(19) United States
(12) Patent Application Publication
(10) Pub. No.: US 2008/0088074 A1
(43) Pub. Date: Apr. 17, 2008

(54) RIGIDITY ADJUSTING MECHANISM

(75) Inventor: Hideaki NAMIKI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/945,038

(22) Filed: Nov. 26, 2007

Related U.S. Application Data
(63) Continuation of application No. PCT/JP2005/009528, filed on May 25, 2005.

(51) Int. Cl. B23Q 3/18

(52) U.S. Cl. 269/59

(57) ABSTRACT

A rigidity adjusting mechanism has: a base; a first columnar member fixed at one end to the base and extending at the other end to a predetermined direction to hold a part holding member; a second columnar member fixed at one end to the base, adjacent to the first columnar member, extending in parallel to the first columnar member, and having higher rigidity than the first columnar member; a connection member movable to a desired position, in the longitudinal direction of both first columnar member and second columnar member, and connecting the first columnar member and the second columnar member; and a fixing section for fixing the connection member to a desired position in the longitudinal direction.

### TECHNICAL FIELD

The present invention relates to a rigidity adjusting mechanism for adjusting rigidity of members constituting equipment.

### BACKGROUND ART

Hitherto, in the welding equipment that welds two parts, for instance, it is necessary to give a special device to the part support mechanism that supports both parts in order to weld parts to be welded maintaining to high accuracy in relative positions of welded parts.

FIG. 13 is a schematic diagram of a part support apparatus of the conventional welding equipment. FIG. 14 and FIG. 15 are explanatory views useful for understanding problems of the part support apparatus shown in FIG. 13.

FIG. 13 shows a part support apparatus 200 used in welding equipment that welds two parts 201 and 202.

The part support apparatus 200 is an apparatus for welding two parts 201 and 202 with maintaining to high accuracy in relative positions of welded parts 201 and 202. The part support apparatus 200 comprises: a pair of part holding members 203 and 204 for holding parts 201 and 202, respectively; a support member 207 for supporting the part 201; a columnar support 209 for supporting the support member 207; a support mechanism 206 for supporting the part holding member 204 that holds the part 202; a base 208 that puts the support mechanism 206; and a support stand 210 for fixing the base 208 and the columnar support 209.

According to the welding equipment as mentioned above, the part support mechanism of the rigidity suitable for two welded parts is selected and used. The use of the part support mechanism of the rigidity not suitable for parts might generate defective goods, for instance, in such a way that the space might be caused by the heat stress on the bonded surface, or the joint of both parts shifts in radius direction, when surroundings on the bonded surfaces of parts 201 and 202 are welded by the laser and the like.

In view of the foregoing, as shown in FIG. 14, in the event that the rigidity of the support mechanism 206 is not suitable for the parts 201 and 202 to be welded, there is a need of positioning of the support mechanism 206 in an arrow A direction, as shown in FIG. 15, to remove the support mechanism 206 from the part support apparatus 200 by removing fixing screws 211, select a support mechanism that is suitable for the parts 201 and 202 from among two or more support mechanisms 206a (low rigidity), 206b (high rigidity), 206c (different material), . . . , which are prepared beforehand, fix the selected support mechanism 206 with the fixing screws 211, and correct discrepancy 212 between the parts each time. More in detail, an exchange of the support mechanism brings about variations in the relative position between the parts in the process of an exchange of the support mechanism, and as a result, procedures such as re-measurement and a positional correction are generated in every case. In order to avoid this problem, it is considered to use a positioning pine 213. However, when it is intended that two or more entire support mechanisms are put in the same allowance, an increase in costs is invited. This is not realistic. Moreover, in the event that it is desired to change the rigidity step by step, it is necessary to prepare the support mechanisms of the number that corresponds to the number of steps to change the rigidity little by little, and it makes it to a high cost. And it involves a problem that the process of an exchange of the support mechanism is increased.

On the other hand, in a field of electric equipment, for example, a field of tape record player, there is disclosed a tape guide mechanism having a shaft that is fixed at one end, and a tape guide that is fixed on a predetermined site of the shaft, for the purpose of enhancement of stability of the tape running, the tape guide mechanism being capable of setting up a resonance mode of the shaft to a desired mode in such a way that rigidity of the shaft is varied by means of applying vibration displacement to the tape guide by vibration means for vibrating the shaft (cf. refer to the following Patent Document 1).

Patent Document 1: Japanese Patent Application Laid-open No. 8-129809 (pages 2-4, FIG. 4)

### DISCLOSURE OF THE INVENTION

However, according to the technology disclosed by Japanese Patent Document TokuKai Hei. 8-129809, the stable running of a tape is achieved by lowering tension of the tape by means of obtaining a desired resonance state by vibrating the tape guide by the vibration means. Thus, it is impossible to utilize the technology mentioned above as technology that solves the problems involved in the conventional part support mechanism, as explained in conjunction with FIG. 13 to FIG. 15.

In view of the foregoing, it is an object of the present invention to provide a rigidity adjusting mechanism capable of adjusting rigidity at a no stage.

To achieve the above-mentioned object, the present invention provides a rigidity adjusting mechanism comprising:

a base;

a first columnar member fixed at one end onto the base and extending at other end to a predetermined direction;

a second columnar member fixed at one end onto the base, adjacent to the first columnar member, extending in parallel to the first columnar member, and having higher rigidity than the first columnar member;

a connection member movable to a desired position, in the longitudinal direction of both first columnar member and second columnar member, and connecting the first columnar member and the second columnar member; and

a fixing section that fixes the connection member onto a desired position in the longitudinal direction.

According to the rigidity adjusting mechanism of the present invention, it is possible to implement a part support apparatus capable of supporting parts with a desired rigidity, for instance. Further, for example, in a part support apparatus that is used in the welding equipment that welds two parts, it is possible to implement a rigidity adjusting mechanism capable of freely adjusting rigidity of a part support member at a no stage without destroying a relative position relation between two parts.

In the rigidity adjusting mechanism according to the present invention as mentioned above, it is preferable that each of the first columnar member and the second columnar member has a guidance section that guides a movement of the connection member in the longitudinal direction.

This feature makes it possible to expect a stable operation of a rigidity adjusting, because a movement of the connection member becomes smooth.

In the rigidity adjusting mechanism according to the present invention as mentioned above, it is preferable that the rigidity adjusting mechanism further comprises:

a driving section that drives the connection member to a desired position in the longitudinal direction;

a sensor that detects a position of the connection member; and

a rigidity control section that drives the driving section in accordance with information from the sensor to move the connection member so that rigidity of the first columnar member is controlled.

This feature makes it possible that the rigidity control section causes the connection member to automatically move to a position wherein a rigidity of the first columnar member becomes a desired rigidity.

As mentioned above, according to the rigidity adjusting mechanism of the present invention, it is possible to implement a rigidity adjusting mechanism capable of adjusting rigidity at a no stage with a simple mechanism.

### BRIEF DESCRIPTION OF THE DRAWINGS

FIG. 1 is a schematic diagram showing an embodiment of a rigidity adjusting mechanism of the present invention.

FIG. 2 is a side view of a fixing section of the rigidity adjusting mechanism according to the present embodiment.

FIG. 3 is a sectional view taken along the line A-A FIG. 2.

FIG. 4 is a view useful for understanding a state of a rigidity adjusting in the rigidity adjusting mechanism according to the present embodiment.

FIG. 5 is a view useful for understanding a directionality of a rigidity adjusting in the rigidity adjusting mechanism according to the present embodiment.

FIG. 6 is a schematic diagram of a rigidity adjusting mechanism according to a second embodiment of the present invention.

FIG. 7 is a schematic diagram of a rigidity adjusting mechanism according to a third embodiment of the present invention.

FIG. 8 is a flowchart useful for understanding control operation in the rigidity adjusting mechanism according to the third embodiment of the present invention.

FIG. 9 is a schematic diagram of a rigidity adjusting mechanism according to a fourth embodiment of the present invention, and a view useful for understanding working contents.

FIG. 10 is a schematic diagram of a rigidity adjusting mechanism according to a fifth embodiment of the present invention.

FIG. 11 is a view showing an example in which the rigidity adjusting mechanism shown in FIG. 10 is applied to a transportation device for persons.

FIG. 12 is a view showing an example in which the rigidity adjusting mechanism shown in FIG. 10 is applied to an artificial leg.

FIG. 13 is a schematic diagram of a part support apparatus of the conventional welding equipment.

FIG. 14 is an explanatory view useful for understanding problems of the part support apparatus shown in FIG. 13.

FIG. 15 is an explanatory view useful for understanding problems of the part support apparatus shown in FIG. 13.

### BEST MODE FOR CARRYING OUT THE INVENTION

Embodiments of the present invention will be described hereinafter in conjunction with the figures.

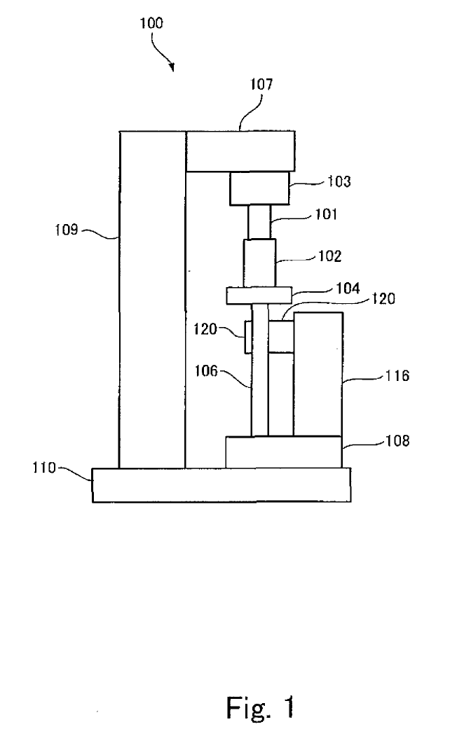

FIG. 1 is a schematic diagram showing an embodiment of a rigidity adjusting mechanism of the present invention.

FIG. 1 shows a part support apparatus 100 for supporting two parts 101 and 102 to be welded, which is used for welding equipment that welds the parts 101 and 102 maintaining to high accuracy in relative positions of the parts 101 and 102.

The part support apparatus 100 includes a rigidity adjusting mechanism comprising: a base 108; a first columnar member 106 fixed at one end to the base 108 and extending at the other end to a predetermined direction to hold a part holding member 104; a second columnar member 116 fixed at one end to the base 108, adjacent to the first columnar member 106, extending in parallel to the first columnar member 106, and having higher rigidity than the first columnar member 106; a connection member 120 movable to a desired position, in the longitudinal direction of both first columnar member 106 and second columnar member 116, and connecting the first columnar member 106 and the second columnar member 116; and a fixing section (not illustrated) for fixing the connection member 120 to a desired position in the longitudinal direction. The details of the fixing section will be described later.

The second columnar member 116 is put on the base 108, and the base 108 is fixed to a support stand 110. A prop 109 is also fixed to the support stand 110. A support member 107 is fixed to the prop 109. The support member 107 serves to support a part holding member 103 for holding a part 101, so that the part 101 held by the part holding member 103 is welded together a part 102 held by the part holding member 104.

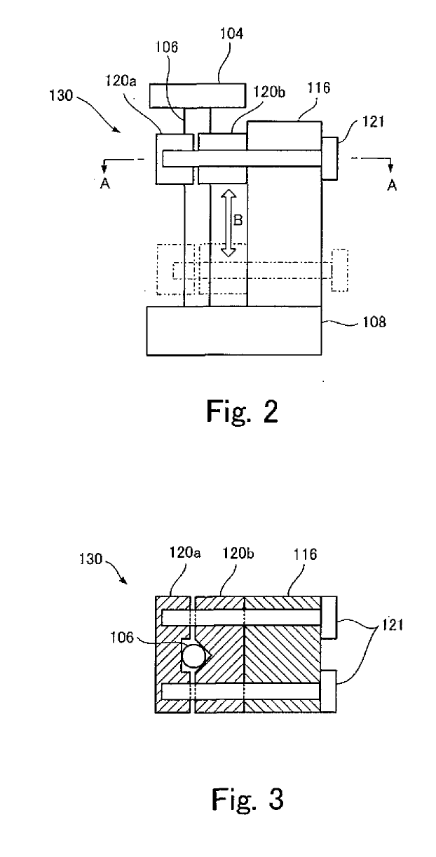

FIG. 2 is a side view of a fixing section of the rigidity adjusting mechanism according to the present embodiment. FIG. 3 is a sectional view taken along the line A-A FIG. 2.

As seen from FIG. 2 and FIG. 3, according to a fixing section 130 of the rigidity adjusting mechanism according to the present embodiment, it is possible to fix connection members 120a and 120b with a bolt 121 to a desired position of the first columnar member 106 and the second columnar member 116 in the longitudinal direction (arrow “B” direction).

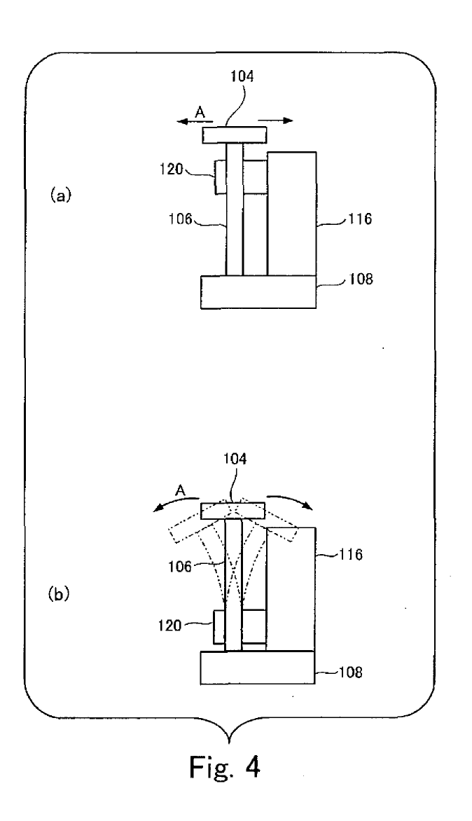

FIG. 4 is a view useful for understanding a state of a rigidity adjusting in the rigidity adjusting mechanism according to the present embodiment.

As shown in part (a) of FIG. 4, in the event that the connection member 120 is fixed to a position nearer the part holding member 104, the first columnar member 106 is higher in support rigidity. To the contrary, as shown in part (b) of FIG. 4, in the event that the connection member 120 is fixed to a position nearer the base 108 for supporting the part support apparatus 100, the first columnar member 106 is lower in rigidity.

Therefore, the rigidity of the first columnar member 106 is higher in case of part (a) of FIG. 4 as compared with case of part (b) of FIG. 4. Thus, the displacement of the part holding member 104 in the direction of arrow A decreases.

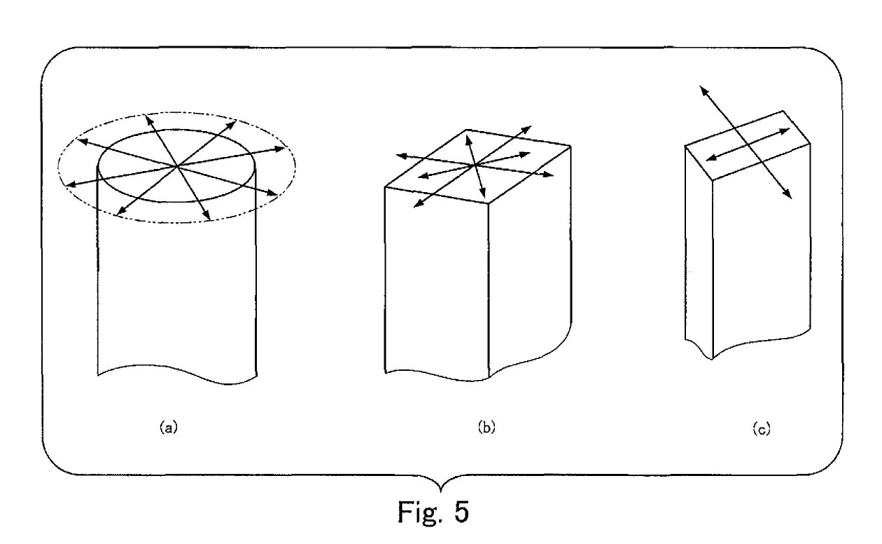

FIG. 5 is a view useful for understanding a directionality of a rigidity adjusting in the rigidity adjusting mechanism according to the present embodiment.

As shown in parts (a), (b), and (c) of FIG. 5, various sorts of directionality can be given to the rigidity of the first columnar member 106 by assuming the section shape of the first the first columnar member 106 to be a circle, a square, and a rectangle, respectively.

Next, there will be explained a second embodiment of the rigidity adjusting mechanism of the present invention.

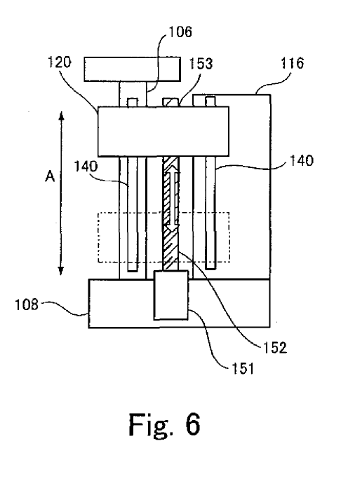

FIG. 6 is a schematic diagram of a rigidity adjusting mechanism according to a second embodiment of the present invention.

As shown in FIG. 6, according to the rigidity adjusting mechanism of the second embodiment, each of the first columnar member 106 and the second columnar member 116 has a guide groove 140 for guiding a movement of the connection member 120 in the arrow “A” direction (the longitudinal direction of the columnar member). The connection member 120 has a projection (not illustrated) that engages with the guide groove 140. The guide groove 140 and the projection correspond to the guidance section referred to in the present invention. However, the guidance section is not restricted to the structure of the guide groove 140 and the projection mentioned above.

Further, according to the second embodiment, the connection member 120 has a screwed runner 153, and there are provided a rotary shaft 152 that is engaged with the screwed runner 153 on a spiral basis, and a motor 151 for driving the rotary shaft 152. Thus, when the motor 151 is rotated, the connection member 120 can be moved to a desired position in an arrow “A” direction. The screwed runner 153, the rotary shaft 152, and the motor 151 correspond to the driving section referred to in the present invention.

Next, there will be explained a third embodiment of a rigidity adjusting mechanism of the present invention.

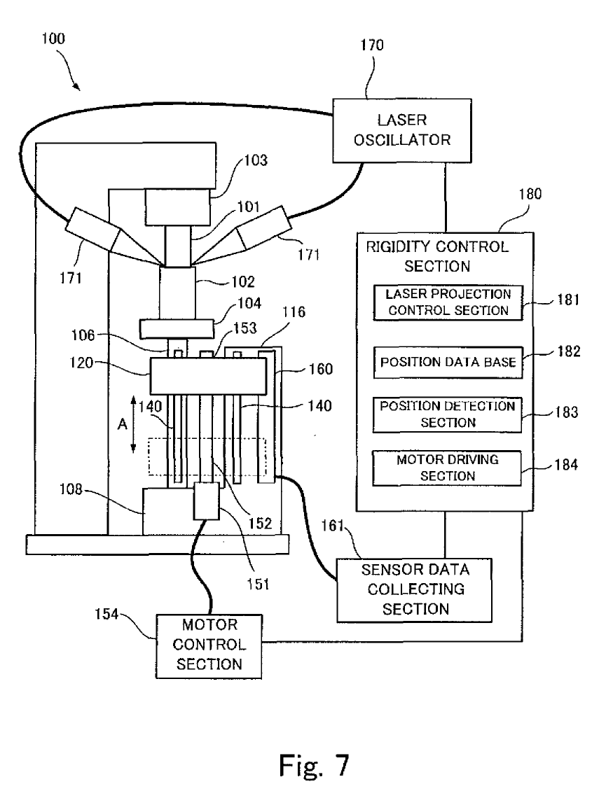

FIG. 7 is a schematic diagram of a rigidity adjusting mechanism according to a third embodiment of the present invention.

As shown in FIG. 7, the rigidity adjusting mechanism according to the third embodiment comprises: in addition to the part support apparatus 100 for supporting two parts 101 and 102 in the first embodiment shown in FIG. 1, a driving section for moving the connection member 120 to a desired position in an arrow “A” direction, the driving section comprising the motor 151, the rotary shaft 152, and the screwed runner 153; a sensor 160 for detecting a position of the connection member 120; a rigidity control section 180 for controlling a rigidity of the first columnar member 106 in such a manner that the above-mentioned driving section is driven in accordance with information from the sensor 160 to move the connection member 120; a laser projection units 171 and 171 for welding parts 101 and 102; a laser oscillator 170; a motor control section 154 for controlling the motor 151; and a sensor data collecting section 161 for collecting data from the sensor 160.

The rigidity control section 180 comprises a laser projection control section 181, a position data base 182, a position detection section 183, and a motor driving section 184.

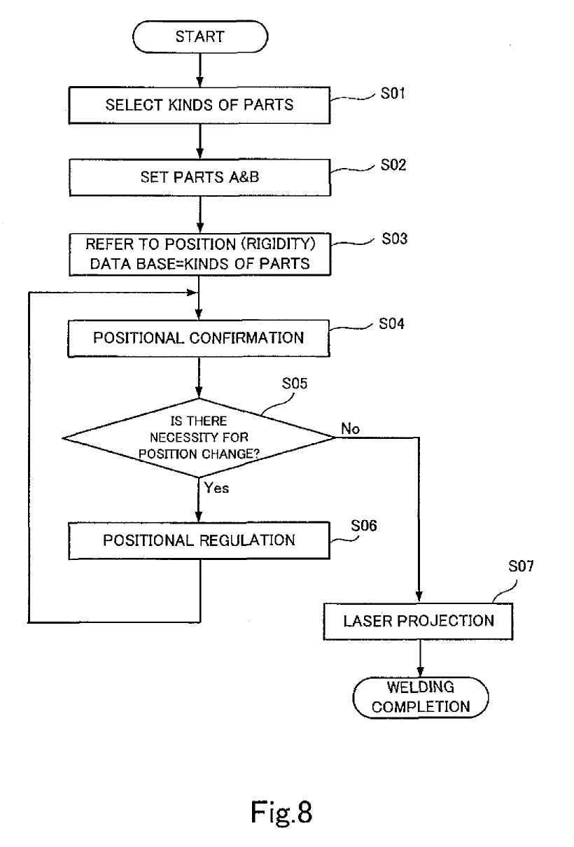

FIG. 8 is a flowchart useful for understanding control operation in the rigidity adjusting mechanism according to the third embodiment of the present invention.

This control operation is executed by the rigidity control section 180 shown in FIG. 7 in accordance with operation of an operator. First of all, the operator selects the kinds of parts to be welded as shown in FIG. 8 (step S01). Next, the parts 101 and 102 are set to the part support apparatus 100 (refer to FIG. 7) (step S02). Next, the rigidity control section 180 refers to the position data base 182 (refer to FIG. 7) to determine a position of the connection member 120 associated with the kind of the parts to be welded, that is, the rigidity (step S03). Next, the sensor data collecting section 161 and the position detection section 183 performs the positional confirmation of the connection member 120 (step S04).

As a result of the positional confirmation, it is decided whether there is a necessity for change of the position (step S05).

When it is decided that there is a necessity for change of the position, as a result of the decision of the step S05, the positional regulation is performed by the motor driving section 184 and the motor control section 154 (step S06). Next, the process returns to the step S04 to repeat the positional confirmation and the subsequent processing.

On the other hand, when it is decided that there is no necessity for change of the position, as a result of the decision of the step S05, the laser projection control section 181 and the laser oscillator 170 cause the laser projection units 171 and 171 to emit laser beams so that welding of the parts 101 and 102 is completed (step S07).

Next, there will be explained a forth embodiment of a rigidity adjusting mechanism of the present invention.

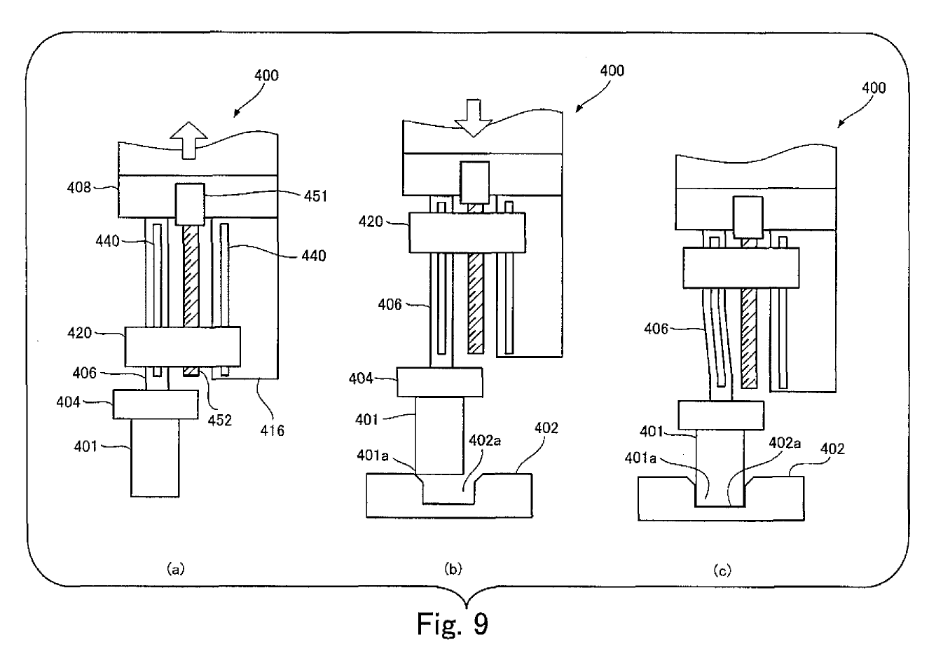

FIG. 9 is a schematic diagram of a rigidity adjusting mechanism according to a fourth embodiment of the present invention, and a view useful for understanding working contents.

As shown in part (a) of FIG. 9, the rigidity adjusting mechanism according to the fourth embodiment of the present invention, which is different from the part support apparatus 100 in the welding equipment shown in FIG. 1, is so arranged that a relative position of a first columnar member 406 and a second columnar member 416 to a base 408 for supporting those two columnar members is reversed in the upper and lower sides, and a first part 401 is supported in a state that a part holding member 404 is hung by the first columnar member 406.

That is, the part support apparatus 400 comprises: a base 408; the first columnar member 406 fixed at one end to the base 408 and at the other end to hold a part holding member 404; the second columnar member 416 fixed at one end to the base 408, adjacent to the first columnar member 406, extending in parallel to the first columnar member 406, and having higher rigidity than the first columnar member 406; a connection member 420 movable to a desired position, in the longitudinal direction of both first columnar member 406 and second columnar member 416, and connecting the first columnar member 406 and the second columnar member 416; and a fixing section (not illustrated) for fixing the connection member 420 to a desired position in the longitudinal direction. The fixing section has the same structure as those of the fixing section 130 shown in FIG. 2 and FIG. 3.

The rigidity adjusting mechanism of the fourth embodiment also has the rigidity adjusting mechanism similar to that of the first embodiment shown in FIG. 4. The rigidity adjusting mechanism of the fourth embodiment has a guide groove 440 similar to that of the second embodiment shown in FIG. 6, a projection that engages with the guide groove 440, a rotary shaft 452, and a motor 451 for driving.

Next, as shown in part (b) of FIG. 9, a first part 401 is mounted on the part holding member 404 of the rigidity adjusting mechanism, and an edge 401a of the first part 401 is inserted into a predetermined hole 402a of a second part 402 that is the work object.

The rigidity adjusting mechanism of the fourth embodiment has the connection member 420 movable to a desired position, in the longitudinal direction of both first columnar member 406 and second columnar member 416, as mentioned above. This feature makes it possible to reduce the rigidity of the first columnar member 406, when the connection member 420 is moved to the part holding member 404 sides, as shown in part (b) of FIG. 9.

Thus, the rigidity of the first columnar member 406 is reduced to be flexible, and as a result, as seen from part (c) of FIG. 9, a degree of freedom of movement of the first part 401, which is mounted on the edge of the first columnar member 406, in right and left directions, becomes large. This feature makes it possible to easily insert the edge 401a of the first part 401 into the hole 402a of the second part 402.

Next, there will be explained a fifth embodiment of a rigidity adjusting mechanism of the present invention.

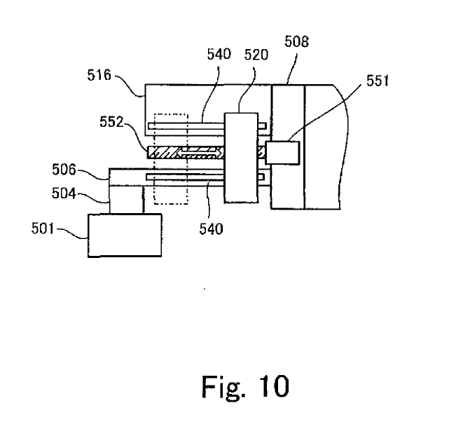

FIG. 10 is a schematic diagram of a rigidity adjusting mechanism according to a fifth embodiment of the present invention.

As shown in FIG. 10, the rigidity adjusting mechanism according to the fifth embodiment of the present invention, which is different from the part support apparatus 100 in the welding equipment shown in FIG. 1, is so arranged that a first columnar member 506 and a second columnar member 516 are arranged in a horizontal direction, and a part 501 is supported in a state that the part 501 is hung by the first columnar member 506 and a part holding member 504.

That is, the part support apparatus 500 comprises: a base 508; the first columnar member 506 fixed at one end to the base 508 and at the other end to hold a part holding member 504; the second columnar member 516 fixed at one end to the base 508, adjacent to the first columnar member 506, extending in parallel to the first columnar member 506, and having higher rigidity than the first columnar member 506; a connection member 520 movable to a desired position, in the longitudinal direction of both first columnar member 506 and second columnar member 516, and connecting the first columnar member 506 and the second columnar member 516; and a fixing section (not illustrated) for fixing the connection member 520 to a desired position in the longitudinal direction. The fixing section has the same structure as those of the fixing section 130 shown in FIG. 2 and FIG. 3. The rigidity adjusting mechanism of the fifth embodiment also has the rigidity adjusting mechanism similar to that of the first embodiment shown in FIG. 4. The rigidity adjusting mechanism of the fifth embodiment has a guide groove 540 similar to that of the second embodiment shown in FIG. 6, a projection that engages with the guide groove 540, a rotary shaft 552, and a motor 551 for driving.

According to the part support apparatus 500, when the part 501 is carried while supported, it is possible to adjust rigidity of the first columnar member 506 in such a manner that the connection member 520 is moved to a desired position along the longitudinal direction of both the first columnar member 506 and the second columnar member 516. This feature makes it possible to freely adjust a degree of impact of parts, for example, wherein the part 501 is made to descend and it comes in contact it with other parts in the lower side. Further, this feature makes it possible to freely adjust a magnitude of the swing to the right and left when part 501 is hung and transported.

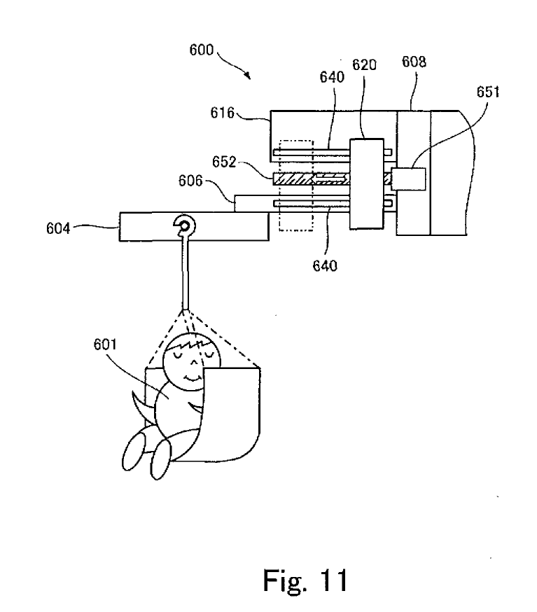

FIG. 11 is a view showing an example in which the rigidity adjusting mechanism shown in FIG. 10 is applied to a transportation device for persons.

As seen from FIG. 11, it is possible to adopt a rigidity adjusting mechanism 600 wherein person 601 is hung and transported from the necessity in nursing etc. instead of the part 501 shown in FIG. 10.

That is, the rigidity adjusting mechanism 600 comprises: a base 608; the first columnar member 606 fixed at one end to the base 608 and at the other end to hold a part holding member 604; the second columnar member 616 fixed at one end to the base 608, adjacent to the first columnar member 606, extending in parallel to the first columnar member 606, and having higher rigidity than the first columnar member 606; a connection member 620 movable to a desired position, in the longitudinal direction of both first columnar member 606 and second columnar member 616, and connecting the first columnar member 606 and the second columnar member 616; and a fixing section (not illustrated) for fixing the connection member 620 to a desired position in the longitudinal direction. The fixing section has the same structure as those of the fixing section 130 shown in FIG. 2 and FIG. 3. This rigidity adjusting mechanism also has the rigidity adjusting mechanism similar to that of the first embodiment shown in FIG. 4. This rigidity adjusting mechanism has a guide groove 640 similar to that of the second embodiment shown in FIG. 6, a projection that engages with the guide groove 640, a rotary shaft 652, and a motor 651 for driving.

According to the rigidity adjusting mechanism 600, when the person is carried, it is possible to adjust rigidity of the first columnar member 606 in such a manner that the connection member 620 is moved to a desired position along the longitudinal direction of both the first columnar member 606 and the second columnar member 616. This feature makes it possible to freely adjust a degree of impact, for example, wherein the person 601 is made to descend. Further, this feature makes it possible to freely adjust a magnitude of the swing to the right and left when person 601 is hung and transported.

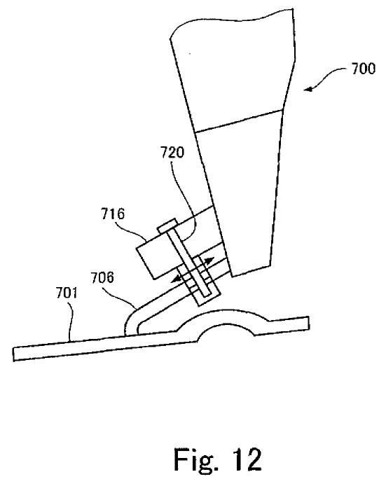

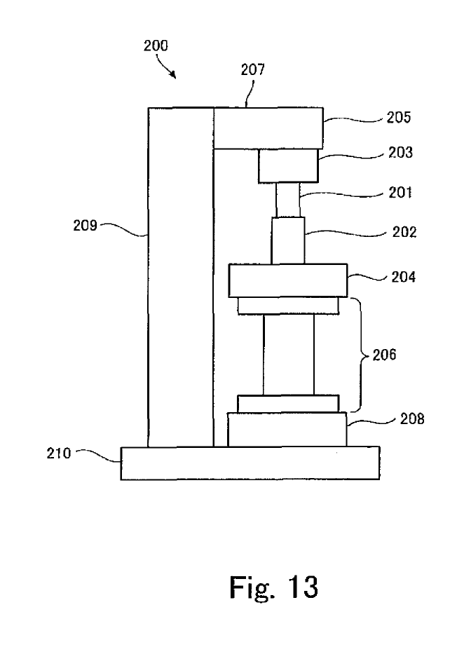

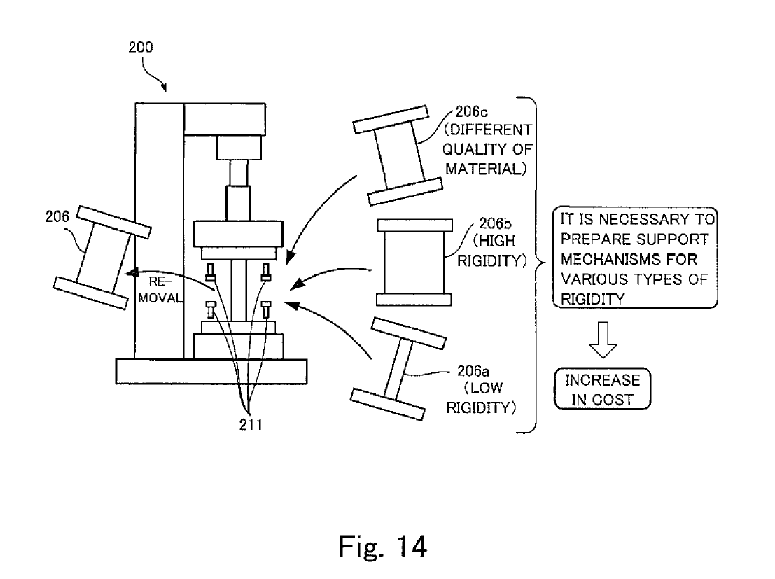

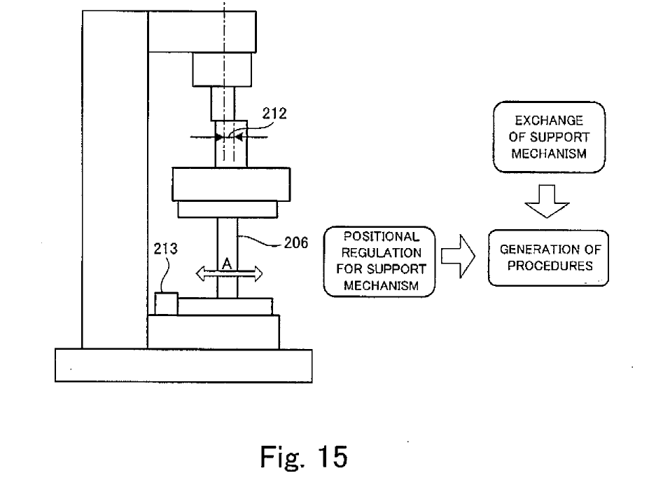

FIG. 12 is a view showing an example in which the rigidity adjusting mechanism shown in FIG. 10 is applied to an artificial leg.

As seen from FIG. 12, the rigidity adjusting mechanism of the present invention can be applied to an artificial leg. That is, in a similar fashion to that shown in FIG. 10, the rigidity adjusting mechanism 700 comprises: a base 708; the first columnar member 706 fixed at one end to the base 708 and at the other end to hold a part holding member 704; the second columnar member 716 fixed at one end to the base 708, adjacent to the first columnar member 706, extending in parallel to the first columnar member 706, and having higher rigidity than the first columnar member 706; a connection member 720 movable to a desired position, in the longitudinal direction of both first columnar member 706 and second columnar member 716, and connecting the first columnar member 706 and the second columnar member 716; and a fixing section (not illustrated) for fixing the connection member 720 to a desired position in the longitudinal direction. The fixing section has the same structure as those of the fixing section 130 shown in FIG. 2 and FIG. 3.

According to the rigidity adjusting mechanism 700, it is possible to adjust rigidity of the first columnar member 706 in such a manner that the connection member 720 is moved to a desired position along the longitudinal direction of both the first columnar member 706 and the second columnar member 716. This feature makes it possible to freely adjust a degree of impact, for example, wherein a leg portion 701 of the artificial leg 700 is made to descend. Further, this feature makes it possible to freely adjust a magnitude of the swing of the leg portion 701.

What is claimed is:

1. A rigidity adjusting mechanism comprising:
a base;
a first columnar member fixed at one end onto the base and extending at other end to a predetermined direction;
a second columnar member fixed at one end onto the base, adjacent to the first columnar member, extending in parallel to the first columnar member, and having higher rigidity than the first columnar member;
a connection member movable to a desired position, in the longitudinal direction of both first columnar member and second columnar member, and connecting the first columnar member and the second columnar member; and
a fixing section that fixes the connection member onto a desired position in the longitudinal direction.

2. A rigidity adjusting mechanism according to claim 1, wherein each of the first columnar member and the second columnar member has a guidance section that guides a movement of the connection member in the longitudinal direction.

3. A rigidity adjusting mechanism according to claim 1, wherein the rigidity adjusting mechanism further comprises:
a driving section that drives the connection member to a desired position in the longitudinal direction;
a sensor that detects a position of the connection member; and
a rigidity control section that drives the driving section in accordance with information from the sensor to move the connection member so that rigidity of the first columnar member is controlled.
